(19) United States
(12) Patent Application Publication
(10) Pub. No.: US 2016/0322168 A1
(43) Pub. Date: Nov. 3, 2016

(54) PROCESS FOR PRODUCING ANODE BODY FOR TUNGSTEN CAPACITOR

(71) Applicant: SHOWA DENKO K.K., Tokyo (JP)

(72) Inventors: Kazumi NAITO, Tokyo (JP); Ryuichi MITSUMOTO, Tokyo (JP)

(73) Assignee: SHOWA DENKO K.K., Tokyo (JP)

(21) Appl. No.: 15/107,507

(22) PCT Filed: Oct. 30, 2014
(86) PCT No.: PCT/JP2014/078951

§ 371 Date: Jun. 23, 2016

(30) Foreign Application Priority Data
Dec. 27, 2013 (JP) 2013-272296

(51) Int. Cl. H01G 9/00; H01G 9/07; C23C 22/02; B22F 3/10; B22F 3/24; H01G 9/052; B22F 1/00

(52) U.S. Cl. CPC H01G 9/0032; H01G 9/052; H01G 9/07; B22F 1/0003; B22F 3/10; B22F 3/24; C23C 22/02; B22F 2003/242; B22F 2301/20; B22F 2998/10

(57) ABSTRACT

A method of producing an anode body of a capacitor, which includes: forming a sintered body of tungsten powder; forming a dielectric body layer on a surface of the sintered body; and bringing the dielectric body layer into contact with an alkoxide compound of a valve metal after the formation of the dielectric body layer. The treatment step is performed so that: (A) a ratio of a mass reduction of the sintered body having formed thereon the dielectric body layer after differential thermal analysis from 100° C. to 300° C. to a mass of the sintered body before the analysis is 0.02% or less; (B) a ratio of a number of atoms of the valve metal other than tungsten to a number of tungsten atoms in a surface layer of the dielectric body layer is from 0.05 to 0.35; or (C) the requirements of (A) and (B) are satisfied.

### TECHNICAL FIELD

The present invention relates to a method of producing an anode body of a capacitor, which is formed of a tungsten sintered body. More specifically, the present invention relates to a method of producing an anode body of a tungsten capacitor having a reduced capacitance change with respect to a direct-current (DC) voltage (bias voltage dependency), and a method of producing a solid electrolytic capacitor.

### BACKGROUND ART

Along with a reduction in size, an increase in speed, and weight saving of electronic devices, such as a mobile phone and a personal computer, a capacitor to be used in these electronic devices is required to have a smaller size, a lighter weight, a higher capacitance, and a lower ESR.

A solid electrolytic capacitor is formed of a conductive body (anode body), for example: an aluminum foil or a sintered body of powder of a metal having a valve action, such as tantalum, niobium, or tungsten, serving as one electrode; a dielectric body layer formed of a metal oxide formed on a surface of the electrode through electrolytic oxidation of a surface layer of the electrode in an electrolyte aqueous solution, such as phosphoric acid; and another electrode (semiconductor layer) formed of a semiconductor layer formed on the dielectric body layer through electrolytic polymerization or the like.

Of the metals having a valve action, an electrolytic capacitor using a sintered body of powder of tungsten as an anode body has an extremely large capacitance change with respect to a DC voltage (bias voltage dependency) as compared to an electrolytic capacitor using an aluminum foil or a sintered body of powder of tantalum or niobium as an anode body, and hence has a problem of a difficulty in its use in a circuit for a precision device, which is required to have a small capacitance change of a capacitor.

### SUMMARY OF INVENTION

### Problem to be Solved by Invention

An object of the present invention is to provide an anode body of a tungsten capacitor in which a capacitance change with respect to a DC voltage (bias voltage dependency) of an electrolytic capacitor using a sintered body of tungsten powder as an anode body is reduced, and an electrolytic capacitor using the anode body.

### Means to Solve Problem

In view of the above-mentioned object, the inventors of the present invention have made extensive investigations, and as a result, found that, when an anode body for an electrolytic capacitor having formed on its surface a dielectric body layer through chemical conversion of a sintered body (anode body) obtained by sintering tungsten powder is treated with a titanium ethoxide solution, among the characteristics of a capacitor, a capacitance change with respect to a DC voltage (bias voltage dependency) is reduced. In addition, the inventors have confirmed that titanium remains in a surface layer of the dielectric body layer. Thus, the present invention has been completed.

That is, the present invention relates to the following method of producing an anode body of a tungsten capacitor and method of producing a solid electrolytic capacitor.

[1] A method of producing an anode body of a capacitor, comprising:

a sintering step of forming a sintered body of tungsten powder;

a chemical conversion step of forming a dielectric body layer on a surface of the sintered body; and

a treatment step of bringing the dielectric body layer into contact with an alkoxide compound of a valve metal after the formation of the dielectric body layer,

the treatment step being performed so that a ratio of a mass reduction of the sintered body having formed thereon the dielectric body layer after differential thermal analysis from 100° C. to 300° C. to a mass of the sintered body before the analysis is 0.02% or less.

[2] The method of producing an anode body of a capacitor according to [1] above, in which the alkoxide compound of a valve metal is an alkoxide compound of titanium or an alkoxide compound of tungsten.
[3] A method of producing an anode body of a capacitor, comprising:

a sintering step of forming a sintered body of tungsten powder;

a chemical conversion step of forming a dielectric body layer on a surface of the sintered body; and

a treatment step of bringing the dielectric body layer into contact with an alkoxide compound of a valve metal other than tungsten after the formation of the dielectric body layer,

the treatment step being performed so that a ratio of a number of atoms of the valve metal other than tungsten to a number of tungsten atoms in a surface layer of the dielectric body layer is from 0.05 to 0.35.

[4] A method of producing an anode body of a capacitor, comprising:

a sintering step of forming a sintered body of tungsten powder;

a chemical conversion step of forming a dielectric body layer on a surface of the sintered body; and

a treatment step of bringing the dielectric body layer into contact with an alkoxide compound of a valve metal other than tungsten after the formation of the dielectric body layer,

the treatment step being performed so that a ratio of a mass reduction of the sintered body having formed thereon the dielectric body layer after differential thermal analysis from 100° C. to 300° C. to a mass of the sintered body before the analysis is 0.02% or less, and a ratio of a number of atoms of the valve metal other than tungsten to a number of tungsten atoms in a surface layer of the dielectric body layer is from 0.05 to 0.35.

[5] The method of producing an anode body of a capacitor according to [3] or [4] above, in which the alkoxide compound of a valve metal other than tungsten is an alkoxide compound of titanium.
[6] A method of producing a solid electrolytic capacitor, using the method of producing an anode body described in any one of [1] to [5] above.

### Advantageous Effects of Invention

In production of an anode body of a capacitor having formed thereon a dielectric body layer formed of a tungsten oxide compound through chemical conversion of a tungsten sintered body, the present invention provides the method of producing an anode body including treating the dielectric body layer with the alkoxide compound of a valve metal.

A capacitor using the anode body produced by the production method of the present invention has a small capacitance change with respect to a DC voltage (bias voltage dependency), and hence can be preferably used in a circuit for a precision device.

### MODE FOR CARRYING OUT INVENTION

As tungsten powder serving as a raw material of a tungsten sintered body (unprocessed tungsten powder, which is hereinafter sometimes referred to as “primary powder”) in the present invention, tungsten powders with a minimum of their average particle diameters of about 0.5 μm are commercially available. Tungsten powder having a smaller particle diameter enables production of a sintered body (anode) having smaller pores. Tungsten powder having a smaller particle diameter than those of the commercially available products may be obtained by, for example, pulverizing tungsten trioxide powder under a hydrogen atmosphere or reducing a tungsten acid or a tungsten halide through use of a reducing agent, such as hydrogen or sodium, under appropriately selected conditions.

In addition, such tungsten powder may also be obtained by directly reducing a tungsten-containing mineral or reducing the tungsten-containing mineral through a plurality of steps under appropriately selected conditions.

In the present invention, the tungsten powder serving as a raw material may be granulated powder (the granulated tungsten powder is hereinafter sometimes referred to simply as “granulated powder”). The granulated powder is preferred by virtue of good flowability and ease of operation, such as molding.

The above-mentioned granulated powder may be subjected to pore distribution adjustment by, for example, a method similar to a method disclosed in JP 2003-213302 A for niobium powder.

The granulated powder may also be obtained by, for example, forming the primary powder into a granular form having an appropriate size through addition of at least one kind of a liquid, such as water, a liquid resin, and the like, followed by heating under reduced pressure and then sintering. Easy-to-handle granulated powder in a granular form may be obtained by appropriately setting reduced pressure conditions (for example, 10 kPa or less in a non-oxidizing gas atmosphere, such as hydrogen) or leaving conditions at high temperature (for example, from 1,100° C. to 2,600° C. for 0.1 hour to 100 hours) through, for example, a preliminary experiment. There is no need to perform crushing when granules do not aggregate after granulation.

The particle diameter of such granulated powder may be uniformized through classification with a sieve. The case in which the granulated powder has an average particle diameter falling within a range of preferably from 50 μm to 200 μm, more preferably from 100 μm to 200 μm is advantageous because such granulated powder smoothly flows from a hopper of a molding machine to a mold.

The case in which the average primary particle diameter of the primary powder falls within a range of from 0.1 μm to 1 μm, preferably from 0.1 μm to 0.3 μm is preferred because, in particular, the capacitance of an electrolytic capacitor produced from its granulated powder can be increased.

When the granulated powder is obtained, it is favorable to make the granulated powder so as to have a specific surface area (by a BET method) of preferably from 0.2 m²/g to 20 m²/g, more preferably from 1.5 m²/g to 20 m²/g through, for example, adjustment of the above-mentioned primary particle diameter because the capacitance of the electrolytic capacitor can be further increased.

In the present invention, in order to improve the leakage current characteristics or the like of a capacitor to be obtained, a tungsten material (including the primary powder, the granulated powder, and the sintered body) may contain some impurities described below.

For example, tungsten powder containing tungsten silicide in a surface layer so as to have a silicon content within a specified range is preferably used. The tungsten powder containing tungsten silicide in a surface layer may be prepared, for example, by mixing 0.05 mass % to 7 mass % of silicon powder with tungsten powder, and then heating the mixture under reduced pressure to allow a reaction at from 1,100° C. to 2,600° C., or by pulverizing tungsten in a hydrogen stream and further mixing silicon powder therewith, and then heating the mixture at a temperature of from 1,100° C. to 2,600° C. under reduced pressure to allow a reaction.

As the tungsten powder, also tungsten powder further containing at least one selected from tungsten nitride, tungsten carbide, and tungsten boride in a surface layer is preferably used.

In the present invention, the tungsten powder is molded into a molded body having a density of preferably 8 g/cm³ or more, and the molded body is heated at a temperature of preferably from 1,480° C. to 2,600° C. for preferably from 10 minutes to 100 hours, to form a sintered body (sintering step).

Next, the surface layer of the sintered body is subjected to electrolytic oxidation (chemical conversion) in an electrolyte aqueous solution (chemical conversion step). Through the chemical conversion, tungsten(VI) oxide, that is, tungsten trioxide (WO₃) is formed on the surface of the sintered body (its outer surface, and the inner surface of a porous part), and serves as a dielectric body coating (dielectric body layer).

Incidentally, tungsten trioxide compounds include a tungsten acid (e.g., H₂WO₄, H₄WO₅), which is a hydrated compound including WO₃ and hydration water, in addition to WO₃. Tungsten trioxide (WO₃) is industrially manufactured by thermally decomposing the tungsten acid at from 900 K to 1,000 K in the atmosphere (Powder and Powder Metallurgy Terminology, p. 312, Nikkan Kogyo Shimbun, Ltd., 2001.). In addition, the tungsten acid is also commercially available in a form of powder as a reagent.

In the production process of a tungsten capacitor, the chemical conversion is performed on the sintered body of metal tungsten serving as an anode body through use of an oxidizing agent aqueous solution. Therefore, it is considered that H₂WO₄, H₄WO₅, or the like, which is a hydrated compound of tungsten trioxide (WO₃), is generated in the chemical conversion.

The inventors of the present invention have confirmed that, when a tungsten anode body having formed thereon a dielectric body layer is left for 1 hour while being immersed in a solution of titanium ethoxide in ethanol, that is, subjected to treatment in which the dielectric body layer is brought into contact with an alkoxide compound of titanium, capacitance at a bias voltage of 3 V is almost the same as capacitance at a bias voltage of 0 V, and hence bias voltage dependency as generally seen is not seen.

The inventors have also confirmed that, when titanium ethoxide is allowed to act, titanium(IV) oxide is generated in the surface layer of the dielectric body coating. As described below, the “surface layer” as used herein refers to a region of the dielectric body coating (dielectric body layer) from its surface to a depth of 30 nm. In addition, for the anode body treated with titanium ethoxide, a mass reduction through heating in differential thermogravimetric analysis (TG-DTA) described below was examined. As a result, a mass reduction corresponding to loss of hydration water was not able to be confirmed. That is, it is considered that, when titanium ethoxide is allowed to act after the chemical conversion, the hydration water is removed from a tungsten acid present in the dielectric body layer to produce tungsten trioxide (WO₃), and hence the characteristics of the capacitor are improved. In addition, the hydration water is lost through the treatment with titanium ethoxide, whereas the hydration water does not enter again to deteriorate the characteristics even though adsorbed water sometimes attaches through leaving under the air.

A possible cause of bias voltage dependency caused by the presence of the hydration water is that the dielectric body formed of a tungsten acid has symmetry distortion owing to the presence of the hydration water, and hence shows spontaneous polarization. Meanwhile, it is considered that tungsten trioxide, in which the hydration water is removed, does not have symmetry distortion, and hence does not exhibit the bias voltage dependency.

An alkoxide compound of titanium used in an embodiment of the present invention is not particularly limited, and examples thereof include titanium tetraethoxide (titanium ethoxide), titanium tetraisopropoxide (titanium isopropoxide), and titanium tetrabutoxide (titanium butoxide). Titanium ethoxide and titanium propoxide are preferred because titanium ethoxide and titanium propoxide are liquids at room temperature, and hence are suitably allowed to act by immersing the anode body therein, and in addition, titanium ethoxide and titanium propoxide can be used by being appropriately diluted with ethanol.

The case in which the anode body is immersed in anhydrous ethanol in advance prior to the above-mentioned immersion is preferred because a solution of the alkoxide compound of titanium easily conforms to the anode body.

After the treatment with the alkoxide compound of titanium, titanium remains as an oxide in the dielectric body coating. The hydrated compound of tungsten trioxide has a large influence on the characteristics of the capacitor, but the oxide of titanium has a small influence on the characteristics of the capacitor because its amount is extremely small, and in addition, titanium is a valve metal.

Temperature at the time of immersion in the solution of the alkoxide compound of titanium only needs to be equal to or higher than the melting points of the alkoxide compound of titanium and a solvent and lower than their boiling points. The alkoxide compound of titanium is preferably allowed to act around room temperature from the viewpoint of ease of handling, or may be allowed to act while being heated to from about 50° C. to about 70° C. from the viewpoint of accelerating a reaction.

A treatment time may be appropriately adjusted in accordance with the temperature. An excessively short treatment time does not provide any effect, but even an excessively long treatment time does not provide a higher effect.

The anode body after the treatment with the alkoxide compound of titanium is preferably subjected to heat treatment. The temperature of the heat treatment is preferably from 100° C. to 250° C., more preferably from 160° C. to 230° C.

While the case of performing the treatment with the alkoxide compound of titanium is given in the above-mentioned exemplary embodiment, the alkoxide compound to be used in the embodiment of the present invention is not limited thereto, and an alkoxide compound of a valve metal may be used. In this case, examples of the valve metal include aluminum, tantalum, niobium, titanium, hafnium, vanadium, zirconium, zinc, molybdenum, tungsten, bismuth, and antimony. Of those, an alkoxide compound of tungsten, which is the same metal as an anode body, is preferred, and an alkoxide compound of titanium is also preferred from the viewpoints of a high dielectric constant of an oxide and ease of handling.

A hydrolysis reaction of a metal alkoxide compound is utilized for synthesis of a metal oxide by a sol-gel method. It is considered that a reaction similar to the synthesis reaction of the metal oxide by the sol-gel method occurs also in the embodiment of the present invention. That is, it is considered that the metal alkoxide takes the hydration water of the hydrated compound of tungsten trioxide in the dielectric body layer to be hydrolyzed, and finally a metal oxide is generated through a reaction similar to the sol-gel method through heating, and remains in the dielectric body layer. Herein, when the metal of the metal alkoxide is a valve metal, the metal oxide to be generated is an oxide of the valve metal. Therefore, the characteristics of the capacitor are not impaired. In addition, as the metal oxide to be generated has a higher dielectric constant, the high dielectric constant of tungsten trioxide is less liable to be impaired.

As described above, when the treatment of bringing the dielectric body layer of the tungsten anode body into contact with the alkoxide compound of a metal is performed, the hydration water of the hydrated compound of tungsten trioxide in the dielectric body layer is removed. The degree of removal of the hydration water may be evaluated by thermogravimetric and differential thermal analysis (TG-DTA). Herein, the mass of the anode body at room temperature subjected to the treatment with the alkoxide compound of a metal is defined as W_{RT}, the mass of the anode body when heated to 100° C. in TG-DTA is defined as W₁₀₀, and the mass of the anode body when heated to 300° C. in TG-DTA is defined as W₃₀₀. In this case, a mass reduction from room temperature to 100° C., (W_{RT}−W₁₀₀), is considered to correspond to the amount of loss of adsorbed water, and a mass reduction from 100° C. to 300° C., (W₁₀₀−W₃₀₀), is considered to correspond to the amount of loss of the hydration water (the amount of the hydration water remaining in the dielectric body layer). Accordingly, the remaining degree of the hydration water in the dielectric body layer can be known from the ratio of the mass reduction from 100° C. to 300° C. to the mass before heating, “(W₁₀₀−W₃₀₀)/W_{RT}”. In the embodiment of the present invention, for the dielectric body layer of the anode body subjected to the treatment with the alkoxide compound of a metal, the value of (W₁₀₀−W₃₀₀)/W_{RT} (mass reduction ratio) needs to be 0.02% or less. When the value is more than 0.02%, the bias voltage dependency of the capacitance is increased.

In addition, metal atoms of the alkoxide compound of a metal finally remain in the surface layer of the dielectric body layer. Herein, the ratio of the number of metal atoms derived from the alkoxide compound of a metal remaining in the surface layer of the dielectric body layer to the number of tungsten atoms, (number of metal atoms/number of tungsten atoms), may be measured by X-ray photoelectron spectrometry (XPS) as described below. In another embodiment of the present invention, the treatment with the alkoxide compound of a metal is performed so that the ratio of the number of metal atoms to the number of tungsten atoms, (number of metal atoms/number of tungsten atoms), falls within a range of from 0.05 to 0.35. When the ratio of the number of metal atoms to the number of tungsten atoms is less than 0.05, the bias voltage dependency of the capacitance is increased.

Further, in a still another embodiment of the present invention, the treatment with the alkoxide compound of a metal is performed so that the value of (W₁₀₀−W₃₀₀)/W_{RT} (mass reduction ratio) for the dielectric body layer of the anode body subjected to the treatment with the alkoxide compound of a metal is 0.02% or less, and the ratio of the number of metal atoms derived from the alkoxide compound of a metal remaining in the surface layer of the dielectric body layer to the number of tungsten atoms, (number of metal atoms/number of tungsten atoms), falls within a range of from 0.05 to 0.35.

### EXAMPLES

The present invention is hereinafter described by Examples and Comparative Examples, but is in no way limited thereto.

The removal of hydration water from a dielectric body layer of an anode body was confirmed by differential thermal analysis (TG-DTA) in which the anode body was heated up to 300° C. in an argon atmosphere. Herein, as described above, a mass reduction from room temperature to 100° C. was considered to correspond to the amount of loss of adsorbed water, and a mass reduction from 100° C. to 300° C. was considered to correspond to the amount of loss of the hydration water of a tungsten acid. In addition, the ratio (mass reduction ratio) of the mass reduction from 100° C. to 300° C. to the mass of the anode body before heating was determined.

Ti/W Ratio:

The XPS spectrum of a dielectric body layer of an anode body was measured with an X-ray photoelectron spectrometer (AXIS Nova, manufactured by Shimadzu Corporation). As a result, it was found that most of titanium (Ti) had a valence of four. A ratio in terms of the number of atoms was calculated from a peak intensity ratio when a peak around 35 eV and a peak around 460 eV were defined as a peak of hexavalent tungsten and a peak of tetravalent titanium, respectively. In addition, the dielectric body layer was analyzed while being etched with argon. As a result, it was found that titanium was present in a region of granulated powder from its surface to a depth of 30 nm. The dielectric body layer was partially reduced through the etching with argon, and the positions of the peaks were changed. The detection depth was about 15 nm in a state without the etching, and it was assumed that the ratio in terms of the number of atoms was not changed up to a depth of 30 nm. The measured value had an error of ±0.05 with respect to the calculated value because the peak of Ti was weak owing to a small number of Ti atoms and overlapped with a background of W.

### Examples 1 to 5 and Comparative Examples 1 and 2

Commercially available tungsten powder having a volume average particle diameter of 0.65 μm was left in a vacuum furnace at 1,400° C. for 30 minutes, and then taken out therefrom at room temperature. The resultant agglomerate was crushed to produce granulated powder having a volume average particle diameter of 75 μm. The powder was molded with a molding machine with a tantalum wire having a diameter of 0.29 mm planted. Further, the resultant was sintered in a vacuum furnace at 1,470° C. for 20 minutes to produce 1,000 sintered bodies each having a size of 1.0 mm×3.0 mm×4.4 mm (mass: 120 mg, the tantalum wire entered inside by 3.4 mm and protruded outside by 6 mm at the center of a surface having a size of 1.0 mm×3.0 mm). Each sintered body was subjected to chemical conversion through use of a 3 mass % ammonium persulfate aqueous solution as a chemical conversion liquid at an initial current density per sintered body of 2 mA and a voltage of 10 V at a temperature of 50° C. for 5 hours, to form a dielectric body layer on the surface of the sintered body (its outer surface, and the inner surface of a porous part). The sintered body was washed with water and then washed with ethanol, to produce a chemically converted sintered body. Anhydrous ethanol was added as a solvent to titanium ethoxide to produce an 80 vol % solution. The chemically converted sintered body was immersed in the titanium ethoxide solution under the temperature and time conditions shown in Examples 1 to 5 and Comparative Example 1 of Table 1 under an argon atmosphere while the solution was stirred with a magnetic stirrer. The chemically converted sintered body was taken out from the titanium ethoxide solution, and then dried at 190° C. for 30 minutes under an argon atmosphere and washed with ethanol.

The chemically converted sintered bodies (anode bodies) produced in Examples 1 to 5 and Comparative Example 1 and the chemically converted sintered body (anode body) of Comparative Example 2 not subjected to the immersion treatment in the titanium ethoxide solution were each measured for the capacitance of a capacitor at each bias voltage of 0 V, 2 V, and 3 V through use of a 50 mass % sulfuric acid aqueous solution as an electrolytic solution. The measurement results (in each example, average value of 30 sintered bodies) are shown in Table 1 together with the presence or absence of a mass reduction examined by TG-DTA and a Ti/W ratio in terms of the number of atoms determined by XPS measurement (in each example, an average value of two sintered bodies). For the “mass reduction by TG-DTA” in Table 1, the case in which the ratio of the mass reduction from 100° C. to 300° C. to the mass before heating (the above-mentioned value of (W₁₀₀−W₃₀₀)/W_{RT}) is 0.02% or less is represented as “absent” and the case in which the ratio is more than 0.02% is represented as “present”.

TABLE 1

| | | | | | Ti/W ratio in | | | |
|---|---|---|---|---|---|---|---|---|
| | | | | | terms of number | | | |
| | | | | Mass | of atoms | Capacitance at each | | |
| | Treatment | | | reduction | (derived from | bias voltage (μF) | | |
| | condition | | | by TG-DTA | WO₃) | 0 V | 2 V | 3 V |
| Example 1 | 25° C. | 2 | hours | Absent | 0.2 | 647 | 644 | 643 |
| Example 2 | 25° C. | 4 | hours | Absent | 0.2 | 649 | 643 | 642 |
| Example 3 | 25° C. | 8 | hours | Absent | 0.2 | 651 | 650 | 649 |
| Example 4 | 50° C. | 1 | hour | Absent | 0.1 | 652 | 652 | 650 |
| Example 5 | 50° C. | 2 | hours | Absent | 0.3 | 660 | 661 | 658 |
| Comparative | 25° C. | 1 | hour | Present | 0 | 785 | 633 | 641 |
| Example 1 | | | | | | | | |

| | | | | | | |
|---|---|---|---|---|---|---|
| Comparative | Without treatment | Present | 0 | 821 | 662 | 660 |
| Example 2 | | | | | | |

### Examples 6 to 9 and Comparative Examples 3 and 4

Sintering and chemical conversion were performed in the same manner as in Example 1 except that the commercially available tungsten powder was mixed with 0.4 mass % of commercially available silicon powder having an average particle diameter of 1 μm, and granulated powder was produced at 1,450° C., and in addition a 4 mass % potassium persulfate aqueous solution was used as the chemical conversion liquid, and the initial current density per sintered body, the voltage, and the temperature were changed to 5 mA, 15 V, and 40° C., respectively. Next, treatment with a titanium alkoxide was performed under the treatment conditions shown in Examples 6 to 9 and Comparative Examples 3 and 4 of Table 2 in the same manner as in Example 1 except that titanium isopropoxide was used as the titanium alkoxide. After that, the capacitance at each bias voltage was measured. The measurement results (in each example, average value of 30 sintered bodies) are shown in Table 2 together with the presence or absence of a mass reduction examined by TG-DTA and a Ti/W ratio in terms of the number of atoms determined by XPS measurement (in each example, an average value of two sintered bodies). The “mass reduction by TG-DTA” in Table 2 is represented in the same manner as in Table 1.

TABLE 2

| | | | | | Ti/W ratio in | | | |
|---|---|---|---|---|---|---|---|---|
| | | | | | terms of number | | | |
| | | | | Mass | of atoms | Capacitance at each | | |
| | Treatment | | | reduction | (derived from | bias voltage (μF) | | |
| | condition | | | by TG-DTA | WO₃) | 0 V | 2 V | 3 V |
| Example 6 | 25° C. | 4 | hours | Absent | 0.1 | 431 | 430 | 428 |
| Example 7 | 25° C. | 8 | hours | Absent | 0.1 | 435 | 437 | 435 |
| Example 8 | 50° C. | 2 | hours | Absent | 0.1 | 434 | 433 | 433 |
| Example 9 | 50° C. | 4 | hours | Absent | 0.2 | 441 | 440 | 439 |
| Comparative | 25° C. | 2 | hours | Present | 0 | 568 | 450 | 448 |
| Example 3 | | | | | | | | |
| Comparative | 50° C. | 1 | hour | Present | 0 | 566 | 424 | 421 |
| Example 4 | | | | | | | | |

As shown in Tables 1 and 2, the anode bodies treated under the conditions of Examples each exhibited a small capacitance change when a DC bias voltage was applied as compared to the anode bodies treated under the conditions of Comparative Examples, and had a good result. In addition, the anode bodies treated under the conditions of Examples do not show a mass reduction corresponding to the loss of hydration water in the evaluation by TG-DTA, and hence it is revealed that the hydration water in the dielectric body layer is removed through the treatment with a titanium alkoxide. Further, when the value of the Ti/W ratio of the number of titanium atoms to the number of tungsten atoms in the surface layer of the dielectric body layer was from 0.05 to 0.35 (in consideration of an error of 0.05), a result of a small bias voltage dependency was obtained.

1. A method of producing an anode body of a capacitor, comprising:
a sintering step of forming a sintered body of tungsten powder;
a chemical conversion step of forming a dielectric body layer on a surface of the sintered body; and
a treatment step of bringing the dielectric body layer into contact with an alkoxide compound of a valve metal after the formation of the dielectric body layer,
the treatment step being performed so that a ratio of a mass reduction of the sintered body having formed thereon the dielectric body layer after differential thermal analysis from 100° C. to 300° C. to a mass of the sintered body before the analysis is 0.02% or less.

2. The method of producing an anode body of a capacitor according to claim 1, in which the alkoxide compound of a valve metal is an alkoxide compound of titanium or an alkoxide compound of tungsten.

3. A method of producing an anode body of a capacitor, comprising:
a sintering step of forming a sintered body of tungsten powder;
a chemical conversion step of forming a dielectric body layer on a surface of the sintered body; and
a treatment step of bringing the dielectric body layer into contact with an alkoxide compound of a valve metal other than tungsten after the formation of the dielectric body layer,
the treatment step being performed so that a ratio of a number of atoms of the valve metal other than tungsten to a number of tungsten atoms in a surface layer of the dielectric body layer is from 0.05 to 0.35.

4. A method of producing an anode body of a capacitor, comprising:
a sintering step of forming a sintered body of tungsten powder;
a chemical conversion step of forming a dielectric body layer on a surface of the sintered body; and
a treatment step of bringing the dielectric body layer into contact with an alkoxide compound of a valve metal other than tungsten after the formation of the dielectric body layer,
the treatment step being performed so that a ratio of a mass reduction of the sintered body having formed thereon the dielectric body layer after differential thermal analysis from 100° C. to 300° C. to a mass of the sintered body before the analysis is 0.02% or less, and a ratio of a number of atoms of the valve metal other than tungsten to a number of tungsten atoms in a surface layer of the dielectric body layer is from 0.05 to 0.35.

5. The method of producing an anode body of a capacitor according to claim 3, in which the alkoxide compound of a valve metal other than tungsten is an alkoxide compound of titanium.

6. A method of producing a solid electrolytic capacitor, using the method of producing an anode body claimed in claim 1.

7. The method of producing an anode body of a capacitor according to claim 4, in which the alkoxide compound of a valve metal other than tungsten is an alkoxide compound of titanium.
